(19) United States
(12) Patent Application Publication
(10) Pub. No.: US 2024/0042499 A1
(43) Pub. Date: Feb. 8, 2024

(54) SYSTEM AND METHOD FOR CLEANING AN OBJECT

(71) Applicant: Illinois Tool Works Inc., Glenview, IL (US)

(72) Inventors: Sheila HAMILTON, Glasgow (GB); Stephen MITCHELL, Glasgow (GB)

(21) Appl. No.: 18/257,042

(22) PCT Filed: Nov. 24, 2021
(86) PCT No.: PCT/US2021/060830

§ 371 Date: Jun. 12, 2023

(30) Foreign Application Priority Data
Dec. 11, 2020 (GB) 2019613.5
Nov. 12, 2021 (GB) 2116286.2

(51) Int. Cl. B08B 7/00; B08B 1/02; B08B 1/04; B08B 1/00; B08B 7/04

(52) U.S. Cl. CPC B08B 7/0057; B08B 1/02; B08B 1/04; B08B 1/007; B08B 7/04

(57) ABSTRACT

The present invention relates generally to a system and a method for cleaning the surface of an object. More particularly, the present invention relates to a system and a method that removes inorganic contaminants from the surface of the object and then activates the surface and removes organic contaminants therefrom. The system for cleaning an object includes a first cleaner (120), including at least one elastomeric roll (122), rotatably mounted to said first cleaner and having a generally cylindrical outer surface configured to contact a first surface of the object for removing inorganic contaminants. The system also includes at least one adhesive roll (424,434), rotatably mounted to said first cleaner and having a generally cylindrical outer surface in contact with a portion of said outer surface of said at least one elastomeric roll. Additionally, the system includes at least one second cleaner (440), configured to operably receive the object from said first cleaner, and comprising an electromagnetic radiation source (342) adapted to selectively emit electromagnetic radiation with a wavelength in a range of 10 nm to 280 nm to irradiate at least the first surface of the object so as to activate at least the first surface and to decontaminate organic contaminants therefrom.

### RELATED APPLICATIONS

The present application claims the benefit of United Kingdom (GB) Patent Application Serial No. 2019613.5, filed Dec. 11, 2020, entitled “SYSTEM AND METHOD FOR CLEANING AN OBJECT,” and to United Kingdom (GB) Patent Application Serial No. 2116286.2, filed Nov. 12, 2021, entitled “SYSTEM AND METHOD FOR CLEANING AN OBJECT.” The entireties of United Kingdom Patent Application Serial No. 2019613.5 and United Kingdom Patent Application Serial No. 2116286.2 are expressly incorporated herein by reference.

### FIELD OF THE DISCLOSURE

The present invention relates generally to a system and a method for cleaning the surface of an object. More particularly, the present invention relates to a system and a method that removes inorganic contaminants from the surface of the object and then activates the surface and removes organic therefrom.

### INTRODUCTION

In manufacturing, for various reasons, many components require cleaning prior to assembly. For example, liquid crystal display (LCD) panels available in televisions, monitors, tablets, phones, and the like require optical polarizing films. These films must be thoroughly cleaned so that contaminants do not degrade or compromise the image quality of the overall LCD panel. Such films are often provided on rolls as continuous substrates or webs. Alternatively, discrete substrates or objects may be provided on a conveyor system.

Systems exist which are capable of cleaning one or both surfaces of a substrate by removing inorganic and other contaminants down to the micron level. However, such systems are incapable of removing contaminants down to a nanometre scale, such as, for example, oligomers, which are not particles per se, but organic chemical conglomerations. Sources of organic contamination may include oils or fingerprints.

Certain known methods of cleaning or removing of organic contamination utilise solvents to dissolve or physically detach contaminants. Other known methods of cleaning employ plasma cleaners to eliminate such organic contaminants. Here, a plasma cleaner generates a plasma through air ionization and passes a substrate surface through the plasma, which effectively vaporizes or tears apart the oligomers or other organic contaminants.

At least one of the drawbacks of the solutions known in the prior art is that these treatments have the potential to cause damage to the substrate, because these treatments are very difficult to control. For example, solvents which remove contaminants can degrade certain substrates upon contact. Furthermore, plasma treatment necessitates using relatively high-power plasma in order to clean organic contaminants.

Plasma systems also require expensive equipment, because of the requirement to operate in a controlled environment, and to electrically control and direct the plasma. Consequently, such treatments are only able to apply cleaning to a narrow area across a substrate surface as it passes through the plasma.

Also, substrates cleaned with plasma still require a further processing step in order to be compatible with further manufacturing processes.

Furthermore, when cleaning substrates, in particular thin films or films with specialist coatings, the currently known methods may damage or inhibit the substrate surface being cleaned. A substrate surface that is damaged or inhibited by aggressive cleaning will eventually impede any subsequent manufacturing steps or even lead to a faulty product. Equally, a substrate surface subject to inadequate cleaning may suffer the same drawbacks. Thus, cleaning of certain substrates may not be feasible, as present systems and techniques cannot remove organic contaminants without degradation.

Therefore, it is an object of the present invention to provide a simple, low cost cleaning system and method without at least some of the drawbacks mentioned above. It is a further object of the invention to provide a cleaning system and method which is easy to control and, particularly, provides cleaning that can be readily tuned to the substrate being cleaned. Yet a further object of the invention is to provide a cleaning system and method for sensitive or fragile substrates. In this way, the system and the method of the invention are capable of providing effective cleaning without inhibiting, disrupting or damaging the film or its surface.

It is a further object of the invention to provide an integrated system capable of removing both, organic and inorganic contaminants from a surface of an object, as well as, activate a surface for immediate use in further manufacturing steps.

### SUMMARY OF THE INVENTION

According to a first aspect of the invention, there is provided a system for cleaning an object, the system including:
a first cleaner, including:
   at least one elastomeric roll, rotatably mounted to said first cleaner and having a generally cylindrical outer surface configured to contact a first surface of the object for removing inorganic contaminants;
   at least one adhesive roll, rotatably mounted to said first cleaner and having a generally cylindrical outer surface in contact with a portion of said outer surface of said at least one elastomeric roll;
at least one second cleaner, configured to operably receive the object from said first cleaner, comprising an electromagnetic radiation source adapted to selectively emit electromagnetic radiation with a wavelength in a range of 10 nm to 280 nm to irradiate at least the first surface of the object so as to activate at least the first surface and to decontaminate organic contaminants therefrom. Preferably, said electromagnetic radiation source may be adapted to selectively emit electromagnetic radiation with a wavelength in a range of 100 nm to 280 nm. Even more preferably, said electromagnetic radiation source may be adapted to selectively emit electromagnetic radiation with a wavelength in a range of 170 nm to 180 nm.

Aptly, said first cleaner may include a first support, the object passing between said at least one elastomeric roll and said first support such that said first support is in contact with a second, opposing surface of the object.

Aptly, said first support may be at least one process roll.

Aptly, said at least one elastomeric roll may be a first elastomeric roll and said first support may include a rotatable second elastomeric roll configured to remove inorganic contaminants from the second surface of the object.

Aptly, the system may further include a second rotatable adhesive roll contactingly engaging with said second elastomeric roll.

Aptly, said at least one second cleaner may be operably contiguous with said first cleaner.

Aptly, said at least one second cleaner may be configured to receive the object directly from said first cleaner.

Aptly, said at least one second cleaner further may include a housing configured to shieldingly encase said electromagnetic radiation source and reflect any electromagnetic radiation emitted from said electromagnetic radiation source back towards at least the first surface of the object.

Aptly, said electromagnetic radiation source may include at least one emitter.

Aptly, said at least one emitter may be a UVC light-emitting diode.

Aptly, said at least one second cleaner may include a primary second cleaner and at least one secondary second cleaner arranged operably contiguous to, and configured to receive the object from, said primary second cleaner.

According to a second aspect of the invention, there is provided a method including the steps of:
receiving the object in a first cleaner which includes at least one elastomeric roll, rotatably mounted thereto, and having a generally cylindrical outer surface configured to contact a first surface of the object for removing inorganic contaminants;
contacting a first surface of the object with said at least one elastomeric roll so as to remove inorganic contaminants from at least a first surface of the object;
passing the object from said first cleaner to a second cleaner, configured to operably receive the object from said first cleaner and including an electromagnetic radiation source;
emitting electromagnetic radiation with a wavelength in a range of 100 nm to 280 nm from the electromagnetic radiation source onto at least the first surface of the object.

Aptly, the method may further include the step of contacting a second opposing surface of the object with a second elastomeric roll so as to remove inorganic contaminants from the second opposing surface.

Aptly, the method may further include the steps of:
passing the object from a primary second cleaner to a secondary second cleaner, operably contiguous to said primary second cleaner, and including a further electromagnetic radiation source; and
emitting electromagnetic radiation with a wavelength in a range of 100 nm to 280 nm from said further electromagnetic radiation source onto the first and/or second surface of the object.

Aptly, the method may include that said electromagnetic radiation source of said primary or secondary second cleaner is adapted to selectively emit electromagnetic radiation with a wavelength in a range of 170 nm to 180 nm.

Certain embodiments provide an advantage of cleaning organic contaminants using a system in a controllable way. In this way, the EM radiation provided by an EM radiation source may by easily operated and adjusted by modifying the power or the wavelength of the EM radiation source. A surface thus may be cleaned with only sufficient power to break down organic contaminants into smaller molecules that may volatilise from the surface.

Certain embodiments provide an advantage that the EM radiation source may be adapted according to one or more specific organic contaminants. Certain embodiments provide an advantage that the EM radiation source may be adapted to provide a specific activation to the substrate surface. Thus, the wavelength or wavelengths of EM radiation may be selected depending on the organic contaminant on the surface. Additionally, or alternatively, certain wavelength of light may be intentionally excluded or filtered out. In this way, the organic cleaner may be adapted to avoid a sensitivity of certain materials or coatings to particular types of light.

Certain embodiments provide an advantage that the film surface may be activated. In other words, the EM radiation of a cleaner, both decontaminates organic contaminants and additionally treats or conditions a substrate. In this way, a substrate or surface may be easily modified, for example to readily accept a further coating or substrate. Furthermore, activation of a surface may be tuned to condition a substrate or surface to react with specific coating or treatment during subsequent manufacturing steps.

Certain embodiments provide an advantage that a cleaner may irradiate EM radiation over a large surface area of an object, and over a range of incident angles. In this way, the substrate surface may be more effectively irradiated to provide activation and decontamination of organic contaminants.

Certain embodiments provide an advantage that a substrate surface may be irradiated with EM radiation of one or more specific wavelengths. In this way, EM radiation light projected onto the surface may be targeted at different organic contaminants.

Certain embodiments provide an advantage that cleaning may be provided in multiple or repeated stages at relatively low cost. In this way, the cleaning system may include multiple cleaning or activation steps. That is, the cleaning system is not limited to a single treatment step due to the prohibitive cost and size of equipment.

Certain embodiments provide an advantage that inorganic and organic cleaning and decontamination of a surface may be carried out without risk of contamination between processing steps. Furthermore, the surface is also activated so that the substrate surface can be used directly in further manufacturing steps without additional processing or treatment.

Certain embodiments restrict or control EM radiation projected from an EM radiation source. In this way, contaminants may be easily and safely removed from a surface without risk of exposure to operators.

### BRIEF DESCRIPTION OF THE DRAWINGS

Embodiments of the invention are now described, by way of example only, hereinafter with reference to the accompanying drawings, in which:

FIG. 1 shows a schematic view of a first example cleaning system according to an aspect of the invention;

FIG. 2 shows a schematic view of the example of FIG. 1, further including a secondary second cleaner for cleaning the first substrate surface;

FIG. 3 shows a schematic view of the example of FIG. 1, further including a housing for the second cleaner;

FIG. 4 shows a schematic view of the example of FIG. 1, further including a second inorganic cleaner;

FIG. 5 shows a schematic view of the example of FIG. 1, further including secondary cleaners for cleaning the second substrate surface;

FIG. 6 shows a schematic view of a further example cleaning system according to an aspect of the invention, adapted to clean discrete objects, and

FIG. 7 shows an example method according to an aspect of the invention.

In the drawings, like reference numerals refer to like parts.

### DETAILED DESCRIPTION

Certain terminology is used in the following description for convenience only and is not limiting. Further, as used herein, the terms ‘received’, ‘conveyed’, ‘mounted’ are intended to include direct connections or relationships between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’, ‘primary’, ‘secondary’ etc. merely indicate that different instances of like objects are being referred to and are not intended to imply that the objects so described must be in a given sequence, either temporally, spatially, in ranking or in any other manner.

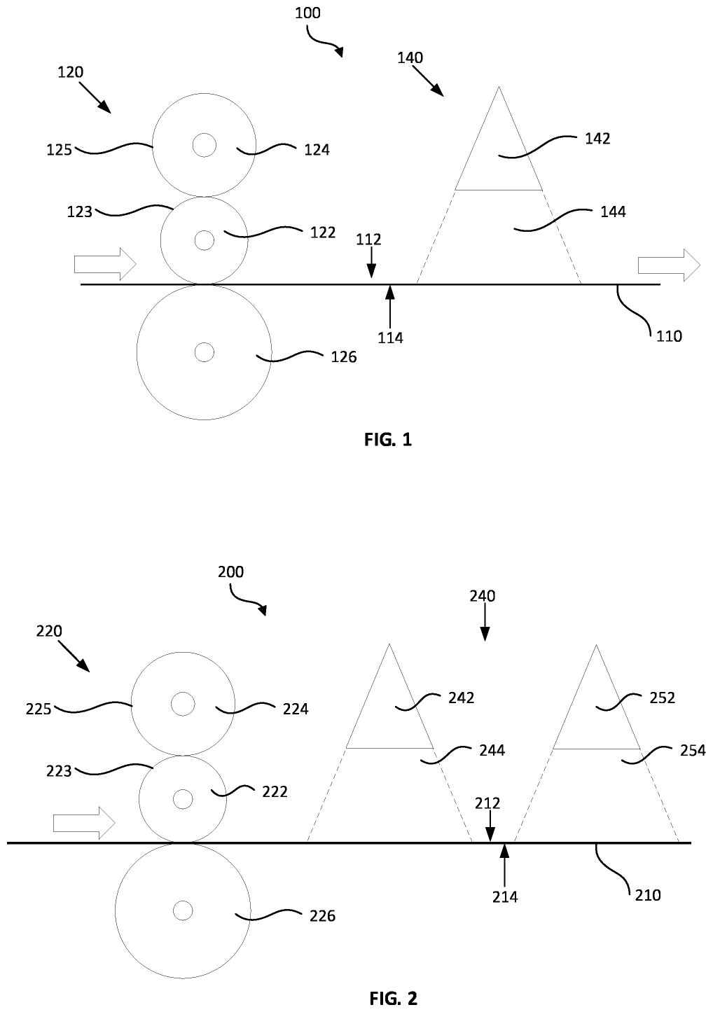

Referring now to FIG. 1, there is shown a cleaning system 100 for cleaning an object 110, according to a first aspect of the invention. In the example of FIG. 1, the object 110 is a continuous sheet substrate 110. The cleaning system 100 includes a first cleaner 120 including an elastomeric roll 122, rotatably mounted thereto, and having a generally cylindrical outer surface, known as cleaning surface 123, configured to contact a first surface 112 of the object or sheet substrate 110 in order to remove inorganic contaminants. The cleaning system 100 also includes a second cleaner 140, configured to receive the sheet substrate 110 from the first cleaner 120, and including an electromagnetic radiation (EMR) source 142 adapted to selectively emit electromagnetic radiation 144 with a wavelength in the range 10 nm (nm=nanometre) to 280 nm in order to irradiate a first surface 112 of the sheet substrate 110. Irradiation of the first surface 112 with electromagnetic radiation 144 activates the first surface 112 and decontaminates organic contaminants therefrom.

The cleaning system 100 has an adhesive roll 124 rotatably mounted to the first cleaner 120. The adhesive roll 124 has a generally cylindrical outer surface, known as an adhesive surface 125, arranged so that a portion of the adhesive surface 125 of the adhesive roll 124 is in contact with a portion of cleaning surface 123 of the elastomeric roll 122. The adhesive surface 125 is adapted to remove accumulated inorganic contaminants from the cleaning surface 123 as the elastomeric roll 122 and adhesive roll 124 rotate relative to one another. In this way, the adhesive surface 125 continually refreshes the cleaning surface 123 for optimal cleaning of the sheet substrate 110.

Further, a process roll 126 is mounted in the cleaning system 100. The process roll 126 has a generally cylindrical outer surface, known as a support surface, that is arranged to contact the second surface 114 of the sheet substrate 110 as it is received by the first cleaner 120. That is, the process roll 126 supports the sheet substrate 110 as it is engaged with the elastomeric roll 122.

The process roll 126 and the elastomeric roll 122 are opposingly arranged with a spacing, or nip gap, therebetween. Thus, the process roll 126 and the elastomeric roll 122 are arranged to respectively engage opposing portions of the first and second surfaces 112, 114 of the sheet substrate 110 as it is received by the first cleaner 120.

The second cleaning system 140 includes an EMR source 142 that is adapted to irradiate the sheet substrate 110 after it has been cleaned by the first cleaner 120. The emitted electromagnetic radiation 144 irradiates a portion of the first surface 112. That is, the emitted electromagnetic radiation 144 irradiates an area of the first surface 112 as the sheet substrate 110 is conveyed within the second cleaner 140.

The EMR source 142 is configured to emit electromagnetic radiation 144 with a wavelength in the range 10 nm to 280 nm. That is, the EMR source 142 is configured to emit UV-C light. Optionally, the EMR source 142 is configured to emit electromagnetic radiation 144 with a wavelength in the range 100 nm to 280 nm. Yet more optionally and preferably, the EMR source 142 is configured to emit electromagnetic radiation 144 with a wavelength in the range 170 nm to 180 nm.

The emitted electromagnetic radiation 144 thus irradiates any organic contaminants on the first surface 112 causing the organic contaminants to break down. Once broken down, the organic contaminants readily evaporate or volatilise from the first surface 112, thereby decontaminating the first surface 112.

The emitted electromagnetic radiation 144 provided by the EMR source 142 is also adapted to activate (while decontaminating) the first surface 112 of the sheet substrate 110. As used herein, “activate” means causing one or more effects on the first surface, including, for example, (i) providing an ionisation of the substrate 110, (ii) providing an electrostatic surface to the substrate 110, or (iii) providing chemical modification of a component of the substrate 110. In this way, the substrate 110 is modified so as to prepare it for subsequent processing.

The EMR source 142 of the second cleaner 140 may be actuated and adjusted (i.e. controlled) by a controller (not shown). The controller may be configured to selectively activate the EMR source 142. Here, selective activation may be in response to one or more sensors adapted, for example, to detect the presence of the sheet substrate 110 within the second cleaner 140 (e.g. at a predetermined location). However, it is understood by the person skilled in the art that selective activation of the EMR source 142 may be in response to any other suitable sensor input (measuring a predetermined parameter), as is the selective deactivation of the EMR source 142.

The controller may further be configured to adjust the characteristics of the electromagnetic radiation 144 emitted by the EMR source 142. For example, the controller may be configured to selectively adjust any one of the wavelength, the wavelength range and the power output of the emitted electromagnetic radiation 144. In this way, the electromagnetic radiation 144 can be “tuned” to the sheet substrate 110 undergoing the cleaning process. Thus, the electromagnetic radiation 144 can be optimised (i.e. maximise efficiency) to the organic contamination on a sheet substrate 110. Additionally, or alternatively, the electromagnetic radiation 144 can be optimised to the composition of the sheet substrate 110, so as to prevent damage or degradation of sensitive substrates and films, or to provide a specific type of activation to a surface.

In use, the cleaning apparatus 100 is configured to convey the sheet substrate 110 in the direction indicated by the arrows of FIG. 1. The sheet substrate 110 is conveyed by one or more known driving means, such as, for example, a conveyor belt or a number of driven process rollers (not shown) suitably positioned before, within and/or after the cleaning apparatus 100.

Additionally, the sheet substrate 110 may be conveyed by driving rotation of the elastomeric roll 122 and the process roll 126. The elastomeric roll 122 may be driven by using a direct drive system or may be driven due to the rotational engagement with a driven adhesive roll.

The sheet substrate 110 is received by the first cleaner 120 such that it engages with the nip gap between the elastomeric roll 122 and process roll 126. That is, the first surface 112 of the sheet substrate 110 contacts the cleaning surface 123 of the elastomeric roll 122, and the second surface 114 contacts the support surface of the process roll 126. Due to the propensity of the cleaning surface 123 to collect inorganic contaminants, they are removed from the first surface 112 as the sheet substrate 110 is conveyed between the nip gap.

As shown in FIG. 1, the second cleaner 140 is positioned “downstream” of the first cleaner 120 (i.e. adjacent to). The second cleaner 140 receives the substrate 110 directly from the first cleaner 120. In this way, as the sheet substrate 110 is dispensed from the first cleaner 120, it is conveyed to the second cleaner 140 without intermediary exposure which may otherwise risk contamination. Therefore, in practice, the second cleaner 140 is arranged operably contiguous with the first cleaner 120.

As the sheet substrate 110 is conveyed through the second cleaner 140, it is irradiated by electromagnetic radiation 144, activating the first surface 112 and removing organic decontaminants, as explained previously.

Referring now to FIG. 2, there is shown a second example embodiment of a cleaning system 200. Where the features are the same as the previous example, the reference numbers are also kept in alignment with the previous example, but with a “2” as the initial digit. In the example shown in FIG. 2, the object is a continuous sheet substrate 210.

Further, FIG. 2 shows a simplified schematic illustration of a cleaning system 200 including a first cleaner 220 and a second cleaner 240. The first cleaner 220 and its features are substantially the same as the first cleaner 120 of the example embodiment shown in FIG. 1, so, for brevity, the details are not repeated here.

The second cleaner 240 of the example of FIG. 2 has a first electromagnetic source (EMR) 242 arranged in series with a second EMR source 252. Each of the first and second EMR sources 242, 252 are substantially the same as the EMR source 142 shown in the example of FIG. 1. The first EMR source 242 may be provided with a different configuration to the second EMR source 252 within the scope of the variants described herein.

In use, the first and second EMR sources 242, 252 are configured to irradiate a first surface 212 of the sheet substrate 210 with a first and second electromagnetic radiation 244, 254, respectively. In this way, the first surface 212 is activated and decontaminated of organic contaminants twice in succession. Thus, the two successive EMR sources 242, 252 irradiate the first surface 212 using comparatively low power yet ensure a more effective treatment than what would be achieved using only a single EMR source (e.g. 142) with a total power output equivalent to the two successive EMR sources 242, 252 combined.

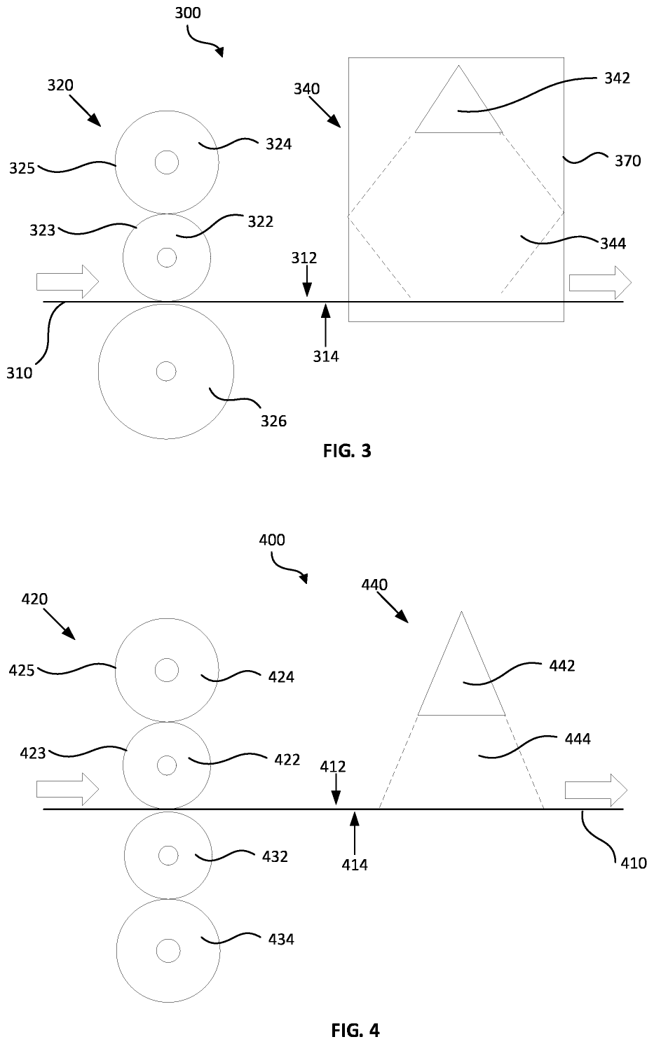

Referring now to FIG. 3, there is shown a third example embodiment of a cleaning system 300. Where the features are the same as the previous example, the reference numbers are also kept the same, but with a “3” as the initial digit. In the example shown in FIG. 3, the object is a continuous sheet substrate 310.

Further, FIG. 3 shows a simplified schematic illustration of a cleaning system 300 including a first cleaner 320 and a second cleaner 340, wherein the second cleaner 340 includes a housing 370 configured to shieldingly encase an electromagnetic radiation source 342 and which is adapted to reflect electromagnetic radiation 344 emitted from the EMR source 342 back towards a first surface 312 of a sheet substrate 310.

The housing 370 is provided with an inlet and an outlet (not shown in detail) so that, in use, the sheet substrate 310 may be conveyed through the second cleaner 340. The second cleaner 340 is positioned “downstream” of (i.e. immediately adjacent to) the first cleaner 320, so that the sheet substrate 310 is received directly from the first cleaner 320 through the inlet. After irradiation by the electromagnetic radiation 344, the sheet substrate 310 is dispensed from the outlet.

As mentioned previously, the housing 370 is adapted to reflect electromagnetic radiation 344 emitted from the EMR source 342. That is, electromagnetic radiation 344 which does not directly irradiate the first surface 312, for example, due to scatter from EMR source 342, or due to reflection from any surface, such as the first surface 312, is thereby reflected back to the first surface 312. In this way, during operation of the second cleaner 340, basically all electromagnetic radiation 344 (not taking any possible leaks or absorption into account) is maintained within the housing 370 (and eventually reflected onto the first surface 312), ensuring safety of operators from the electromagnetic radiation and increasing efficiency of the second cleaner 340.

Referring now to FIG. 4, there is shown a fourth example embodiment of a cleaning system 400. Where the features are the same as the previous example, the reference numbers are also kept the same, but with a “4” as the initial digit. In the example of FIG. 4, the object is a continuous sheet substrate 410.

Further, FIG. 4 shows a simplified schematic illustration of a cleaning system 400 including first and second cleaners 420, 440 wherein the first cleaner 420 includes a first elastomeric roll 422 mounted so as to contact and remove inorganic contaminants from a first surface 412 of a sheet substrate 410, and a second elastomeric roll 432 mounted so as to contact and remove inorganic contaminants from a second surface 414 of the sheet substrate 410.

The second cleaner 440 and its features are substantially the same as the second cleaner 140 of the example embodiment shown in FIG. 1 so, for brevity, the details are not repeated here.

The first cleaner 420 includes a first elastomeric roll 422 mounted so as to contact and remove inorganic contaminants from a first surface 412 of the sheet substrate 410 in the same manner as the elastomeric roll 122 of the example embodiment shown in FIG. 1. Thus, in use, the cleaning surface 423 of the first elastomeric roll 422 is operable to remove inorganic contaminants from the first surface 412 and the cleaning surface 423 is refreshed by the removal of accumulated inorganic contaminants due to the engagement with the adhesive surface 425 of the first adhesive roll 424.

The first cleaner 420 also includes a second elastomeric roll 432 mounted so as to contact and remove inorganic contaminants from a second surface 414 of the sheet substrate 410. The second adhesive roll 434 is rotatably mounted proximal to the second elastomeric roll 432. The second adhesive roll 434 includes an outer adhesive surface that is configured and arranged to operate in substantially the same manner as the corresponding adhesive surface 425 of the first adhesive roll 424. Thus, by engagement with the adhesive surface of the second adhesive roll 434, the cleaning surface of the second elastomeric roll 432 is refreshed by the removal of accumulated inorganic contaminants.

The first and second elastomeric rolls 422, 432 are opposingly arranged with a spacing or nip gap, therebetween. That is, the first and second elastomeric rolls 422, 432 are arranged to respectively engage opposing portions of the first and second surfaces 412, 414 of the sheet substrate 410 as it is received by the first cleaner 420.

In use, the cleaning system 400 is adapted to treat the sheet substrate 410 in the same direction and manner as described in respect of the example embodiment shown in FIG. 1. The first and second surfaces 412, 414 are cleaned of inorganic contaminants by the first and second elastomeric roll 422, 432 of the first cleaner 420. The sheet substrate 410 is then conveyed to and received directly by the second cleaner 440. The EMR source 442 of the second cleaner 440 irradiates the first surface 412 so as to activate it, as well as, decontaminate organic contaminants therefrom.

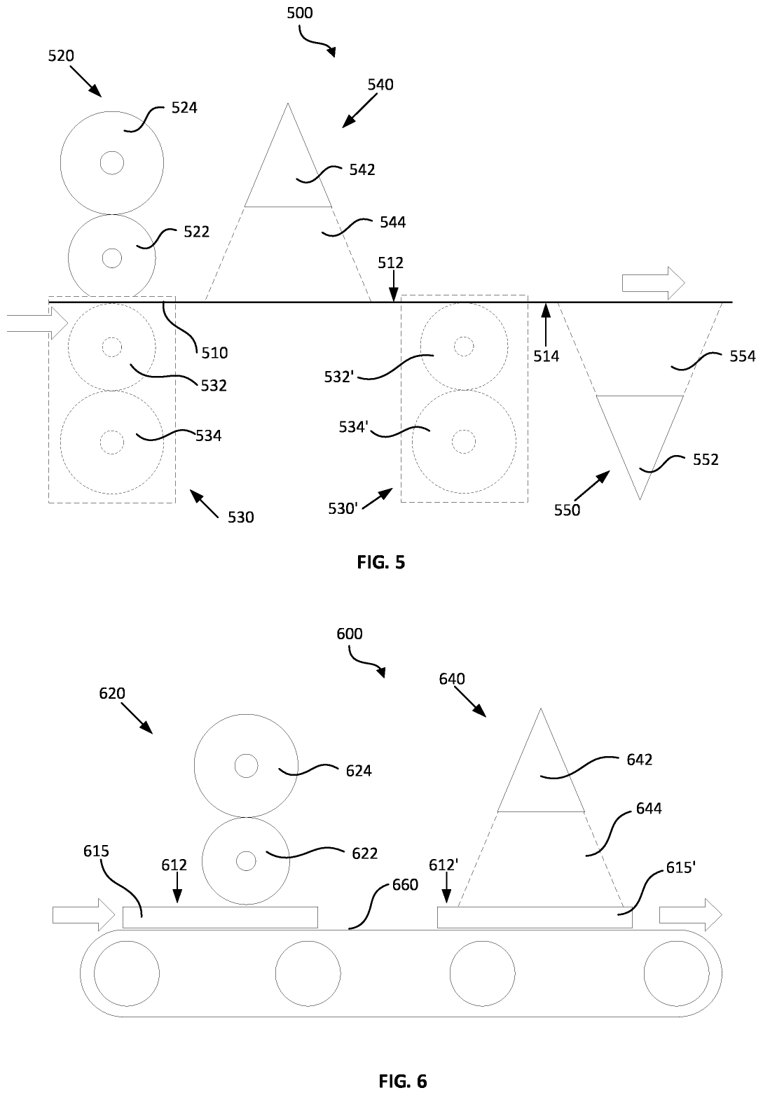

Referring now to FIG. 5, there is shown a cleaning system 500 according to a fifth example embodiment of the present invention. Where the features are the same as the previous example, the reference numbers are also kept the same, but with a “5” as the initial digit. In the example of FIG. 5, the object is a continuous sheet substrate 510.

Further, FIG. 5 shows a simplified schematic illustration of a cleaning system 500 including a primary first 520 and second cleaner 540, as well as, a secondary second cleaner 550. The secondary second cleaner 550 includes a further EMR source 552 adapted to irradiate the second surface 514 of the sheet substrate 510 so as to activate the second surface 514 and to decontaminate organic contaminants therefrom.

The primary first and second cleaners 520, 540 and their respective features are arranged and configured substantially the same as the first and second cleaners 120, 140 of the example embodiment shown in FIG. 1 so, the details are not repeated here.

The secondary second cleaner 550 and its features are arranged and configured substantially the same as the primary second cleaner 540, apart from that the EMR source 552 irradiates the second surface 514 of the sheet substrate 510.

In use, the first surface 512 is cleaned of inorganic contaminants by the primary first elastomeric roll 522 of the first cleaner 520. The sheet substrate 510 is then conveyed to and received directly by the primary second cleaner 540. The EMR source 542 of the primary second cleaner 540 irradiates the first surface 512 so as to activate it as well as decontaminate organic contaminants, therefrom.

Subsequently, the sheet substrate 510 is then conveyed to and received directly by the secondary second cleaner 550. The EMR source 552 of the secondary second cleaner 550 irradiates the second surface 514, so as to activate it, as well as, decontaminate organic contaminants, therefrom.

Optionally, the cleaning system 500 may include a secondary first cleaner 530 to remove inorganic contaminants from the second surface 514. The cleaning system 500 may thus be arranged in a number of appropriate configurations. For example, the secondary first cleaner 530 may be positioned “downstream” of both, the first primary cleaner 520 and the second primary cleaner 540. In this way, the second surface 514 is operably cleaned after the first surface 512.

Alternatively, the secondary first cleaner 530′ may be opposingly arranged with the primary first cleaner 520 in the manner described above in relation to the example of FIG. 4. In this way, the inorganic contaminants are removed from both the first surface 512 and the second surface 514 prior to irradiation of the first surface 512 and the second surface 514. That is, all inorganic contaminants are removed from the sheet substrate 510 prior to activation of the sheet substrate 510 surfaces 512, 514 and respective decontamination from organic contaminants.

The secondary second cleaner 550 may be opposingly arranged with the primary second cleaner 540. In this way, in use, the first and second surfaces 512, 514 are operably irradiated at the same time. Alternatively, the secondary second cleaner 550 may be arranged “downstream” of the primary second cleaner 540. In this way, in use, the first surface 512 is operably irradiated prior to the second surface 514. Each of the primary and secondary EMR sources 542, 552 are substantially the same as in the example embodiment shown in FIG. 1. The first source 542 may be provided with a different configuration to the second source 552 within the scope of the variants described herein.

Referring now to FIG. 6, there is shown a sixth example embodiment of the cleaning system 600. Where the features are the same as the previous example, the reference numbers are also kept the same, but with a “6” as the initial digit. In the example of FIG. 6, the object is a discrete object.

Further, FIG. 6 shows a simplified schematic illustration of a cleaning system 600 including a first cleaner 620 and a second cleaner 640, each one adapted to clean discrete objects.

The first and second cleaners 620, 640 and their respective features are substantially the same as the first and second cleaners 120, 140 of the example embodiment shown in FIG. 1 so, for brevity, the details are not repeated here.

The cleaning system 600 includes a conveyor system adapted to convey objects 615, 615′ through the cleaning system 600. The conveyor system includes a belt 660 as support for the objects 615, 615′ within the cleaning system 600. In this way, the objects 615, 615′ rest with a respective first surface 612, 612′ facing away from the belt 660.

As will be readily apparent, in use, a conveyor system may support a number of objects within the cleaning system 600 depending upon the dimensions of the objects 615, 615′ and the spatial capacity of the conveyor system. A plurality of objects 615, 615′ may be disposed in a machine direction (see arrows) of the belt 660 at any one time. One or more objects 615, 615′ may also be disposed in a transverse direction across the belt 660 (e.g. in parallel). The example embodiment in FIG. 6 only shows representative first and second objects 615, 615′.

In use, the objects 615, 615′ are conveyed sequentially through the cleaning system 600. Within the first cleaner 620, the elastomeric roll 622 contactingly engages an object, in this case the first object 615, and removes inorganic contaminants from its first surface 612 in substantially the same manner as described with reference to any of the previous example embodiments.

Subsequently, the object 615′ is conveyed to the second cleaner 640 where the EMR source 642 irradiates the first surface 612′ with electromagnetic radiation 644, so as to activate it and decontaminate organic contaminants therefrom.

As mentioned previously, the EMR source 642 of the second cleaner 640 may be actuated and adjusted by a controller (not shown). Thus, in the example embodiment shown in FIG. 6, the controller may be configured to selectively activate the EMR source 642 in response to at least one sensor detecting, for example, the presence of each object 615, 615′ as it approaches the second cleaner 640. Once an object 615, 615′moves beyond the second cleaner 640 the EMR source 642 may be selectively deactivated in response to the sensor detecting, for example, the absence of the object 615, 615′. The selective (automatic) activation and deactivation of the EMR source 642 minimises energy usage, thus, optimising its efficiency.

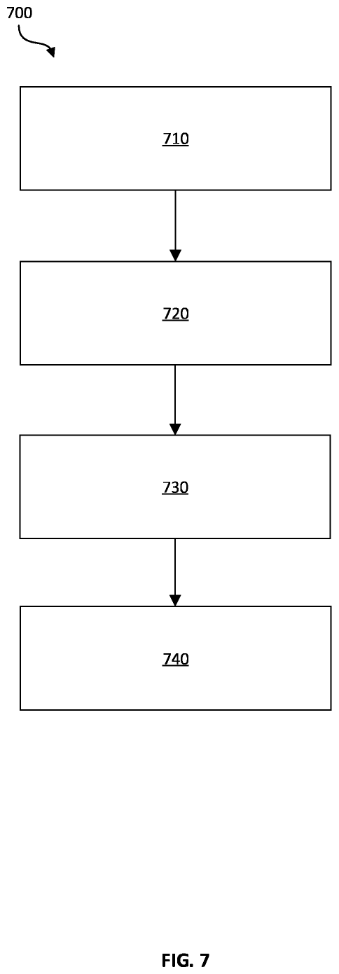

FIG. 7 shows a flowchart illustrating a method 700 of cleaning an object according to a second aspect of the invention. The method 700 starts by receiving 710 an object in a first cleaner, which includes at least one elastomeric roll, mounted and arranged in substantially the same way as the example embodiment described herein.

In the next step 720, a first surface of the object is contactingly engaged with at least one elastomeric roll, so as to remove inorganic contaminants from at least a first surface of the object. In step 730, the object is passed from the first cleaner to a second cleaner that is configured to receive the object from the first cleaner and which has an EMR source. In the final step 740, the second cleaner emits electromagnetic radiation with a wavelength in a range of 100 nm to 280 nm from the EMR source onto at least the first surface of the object, so as to decontaminate, as well as, activate at least the first surface of the object.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible, for example, variations may exist in the number, shape, size, arrangement, assembly or the like of elastomer rolls, cleaning surfaces, adhesive roll or adhesive surfaces.

In the examples described with respect to FIGS. 1 to 6, the area of sheet substrate surface irradiated by the radiation sources encompasses the entire width of the sheet substrate, as well as a length of the sheet substrate in the machine direction. Suitably, an EMR source may be adapted to irradiate any appropriate area on the first surface. For example, the area may form a line or narrow band on the first surface or, alternatively, may extend a substantial length in the machine direction. Optionally, the irradiated area may extend only across a portion of the width of the sheet substrate. In this way, the electromagnetic radiation source may be adapted to activate and decontaminate a specific portion of the sheet substrate as it is conveyed through the second cleaner.

Further, the EMR source may be configured to emit radiation having a spectrum of wavelengths in the range of 10 nm to 280 nm, as well as, radiation of a specific wavelength. Additionally, or alternatively, the EMR source may comprise a filter (optical) configured to selectively transmit a predetermined wavelength or range(s) of wavelengths of the electromagnetic radiation emitted from the EMR source.

The wavelength or range of wavelengths of the emitted electromagnetic radiation may be “tuned” to specific contaminants, and/or “tuned” to activate specific target chemical functional groups of the film itself (substrate surface).

1. A system for cleaning an object, the system comprising:
a first cleaner, including:
at least one elastomeric roll, rotatably mounted to said first cleaner and having a generally cylindrical outer surface configured to contact a first surface of the object for removing inorganic contaminants;
at least one adhesive roll, rotatably mounted to said first cleaner and having a generally cylindrical outer surface in contact with a portion of said outer surface of said at least one elastomeric roll;
at least one second cleaner, configured to operably receive the object from said first cleaner, and comprising an electromagnetic radiation source adapted to selectively emit electromagnetic radiation with a wavelength in a range of 10 nm to 280 nm to irradiate at least the first surface of the object so as to activate at least the first surface and to decontaminate organic contaminants therefrom.

2. The system for cleaning an object according to claim 1, wherein said electromagnetic radiation source is adapted to selectively emit electromagnetic radiation with a wavelength in a range of 100 nm to 280 nm.

3. The system for cleaning an object according to claim 2, wherein said electromagnetic radiation source is adapted to selectively emit electromagnetic radiation with a wavelength in a range of 170 nm to 180 nm.

4. The system for cleaning an object according to claim 1, wherein said first cleaner comprises a first support, the object passing between said at least one elastomeric roll and said first support such that said first support is in contact with a second, opposing surface of the object.

5. The system for cleaning an object according to claim 4, wherein said first support is at least one process roll.

6. The system for cleaning an object according to claim 4, wherein said at least one elastomeric roll is a first elastomeric roll and said first support comprises a rotatable second elastomeric roll configured to remove inorganic contaminants from the second surface of the object.

7. The system for cleaning an object according to claim 6, further comprising a second rotatable adhesive roll contactingly engaging with said second elastomeric roll.

8. The system for cleaning an object according to claim 1, wherein said at least one second cleaner is operably contiguous with said first cleaner.

9. The system for cleaning an object according to claim 8, wherein said at least one second cleaner configured to receive the object directly from said first cleaner.

10. The system for cleaning an object according to claim 1, wherein said at least one second cleaner further comprises a housing configured to shieldingly encase said electromagnetic radiation source and reflect any electromagnetic radiation emitted from said electromagnetic radiation source back towards at least the first surface of the object.

11. The system for cleaning an object according to claim 1, wherein said electromagnetic radiation source comprises at least one emitter.

12. The system for cleaning an object according to claim 1, wherein said at least one emitter is a UVC light-emitting diode.

13. The system for cleaning an object according to claim 1, wherein said at least one second cleaner comprises a primary second cleaner and at least one secondary second organic cleaner arranged operably contiguous to, and configured to receive the object from, said primary second cleaner.

14. A method for cleaning an object, comprising:
receiving the object in a first cleaner according to claim 1;
contacting a first surface of the object with said at least one elastomeric roll so as to remove inorganic contaminants from at least a first surface of the object;
passing the object from said first cleaner to a second cleaner according to claim 1, and
emitting electromagnetic radiation with a wavelength in a range of 100 nm to 280 nm from the electromagnetic radiation source onto at least the first surface of the object.

15. The method according to claim 14, further comprising:
contacting a second opposing surface of the object with a second elastomeric roll so as to remove inorganic contaminants from the second opposing surface.

16. The method for cleaning an object according to claim 14, the method further comprising:
passing the object from a primary second cleaner to a secondary second cleaner, operably contiguous to said primary second cleaner, and comprising a further electromagnetic radiation source; and
emitting electromagnetic radiation with a wavelength in a range of 100 nm to 280 nm from said further electromagnetic radiation source onto at least one of the first surface or the second surface of the object.

17. The method of cleaning an object according to claim 14, wherein said electromagnetic radiation source of said primary or secondary second cleaner is adapted to selectively emit electromagnetic radiation with a wavelength in a range of 170 nm to 180 nm.
